(19) United States
(12) Patent Application Publication
(10) Pub. No.: US 2023/0193949 A1
(43) Pub. Date: Jun. 22, 2023

(54) BALL MOUNT FOR AN ACCESSORY DEVICE

(71) Applicant: Gary Andrew Myers, Chandler, AZ (US)

(72) Inventor: Gary Andrew Myers, Chandler, AZ (US)

(21) Appl. No.: 17/559,066

(22) Filed: Dec. 22, 2021

(51) Int. Cl. F16C 11/06; F16M 11/14; F16M 13/02

(52) U.S. Cl. CPC F16C 11/0657; F16C 11/069; F16M 11/14; F16M 13/022

(57) ABSTRACT

A ball mount for an accessory device is provided. The ball mount may include a rectilinear base, such as, but not limited to a square, that is configured to couple within a recess of similar shape formed in a mounting base. The sides and bottom surface of rectilinear base of the ball mount engages the sides and recessed surface of the recess of the mounting base. This engagement prevents rotation of the ball mount with respect to the mounting base and inhibits loosening of the ball mount from the mounting base. A system that includes the ball mount and mounting base is also provided that allows for the attachment of the ball mount to a vehicle that is not originally equipped for the attachment of a ball mount.

### BACKGROUND OF THE INVENTION

### Technical Field

This invention relates generally to a ball mount, and more specifically for a ball mount for an accessory device, such as a mobile computing device, a camera or the like.

### State of the Art

The use of mobile computing devices and cameras on vehicles is ever growing. This is particularly true when it comes to off road vehicles, motorcycles and the like. Mounts exist that allow the devices to be attached to off road vehicles, and some use a ball mount, however, these existing ball mounts suffer from issues related to loosening of the ball mount from the mounting base/bracket. This occurs for many reasons, one of which includes the vibrations that are caused by the surface the vehicle is travelling that causes rotation of the ball mount and therefore rotation of the bolt attaching the ball mount to its mounting base.

Accordingly, there is a need for an improved ball mount for an accessory device that inhibits loosening of the ball mount from its mounting base.

### SUMMARY OF THE INVENTION

An embodiment includes a ball mount comprising: a ball portion; a rectilinear base; a shaft coupled between rectilinear base and the ball portion; and an aperture extending through the ball portion, the shaft and the rectilinear base, wherein: the ball mount is coupled to a mounting base with a bolt extending through the aperture and coupling to the mounting base; and the rectilinear base is configured to couple to within a recess of the mounting base having a corresponding rectilinear shape.

Another embodiment includes a ball mount system comprising: a ball mount comprising: a ball portion; a rectilinear base; a shaft coupled between rectilinear base and the ball portion; and an aperture extending through the ball portion, the shaft and the rectilinear base; and a mounting base configured to couple to a vehicle, the mounting base comprising a rectilinear recess having a corresponding shape to the rectilinear base of the ball mount, wherein: the ball mount is coupled to the mounting base with a bolt extending through the aperture and coupling to the mounting base; and the rectilinear base is configured to couple to within the rectilinear recess of the mounting base.

Yet another embodiment includes a method of using a ball mount comprising: providing a ball mount comprising: a ball portion; a rectilinear base; a shaft coupled between rectilinear base and the ball portion; and an aperture extending through the ball portion, the shaft and the rectilinear base; coupling the ball mount to a mounting base with a bolt extending through the aperture and coupling to the mounting base; and inhibiting rotation of the ball mount in response to coupling the rectilinear base within a recess of the mounting base having a corresponding rectilinear shape.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a ball mount coupled to a mounting base, according to an embodiment;

FIG. 2 is a perspective exploded view of a ball mount coupled to a mounting base, according to an embodiment;

FIG. 3 is a perspective view of a ball mount, according to an embodiment;

FIG. 4 is a side view of a ball mount, according to an embodiment;

FIG. 5 is a top view of a ball mount, according to an embodiment; and

FIG. 6 is a bottom view of a ball mount, according to an embodiment.

### DETAILED DESCRIPTION OF EMBODIMENTS OF THE INVENTION

As discussed above, embodiments of the present invention relate to ball mount for an accessory device that includes a rectilinear base that is configured to couple within a recess of similar shape formed in a mounting base. This prevents rotation of the ball mount with respect to the mounting base and inhibits loosening of the ball mount from the mounting base.

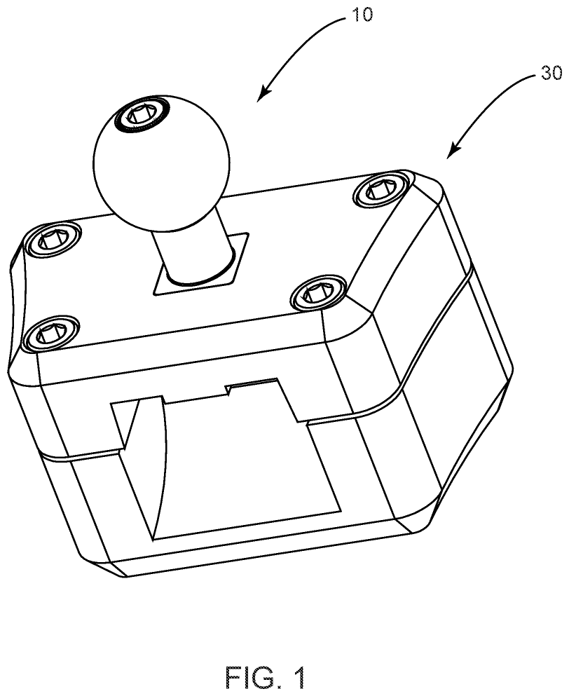

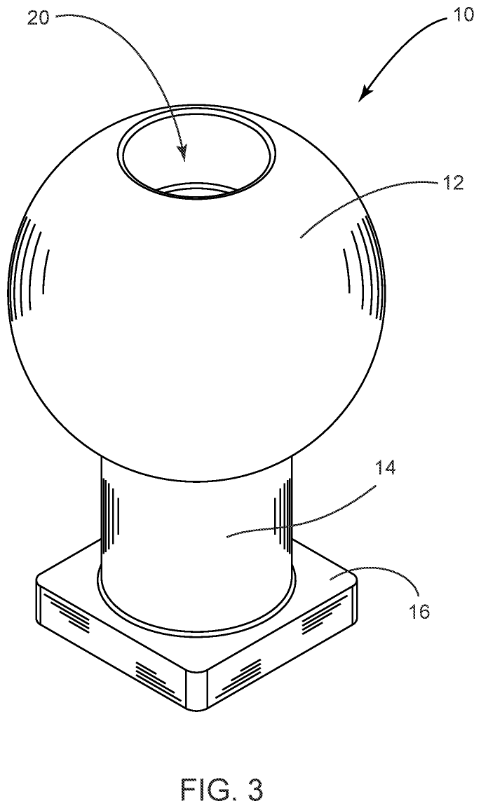

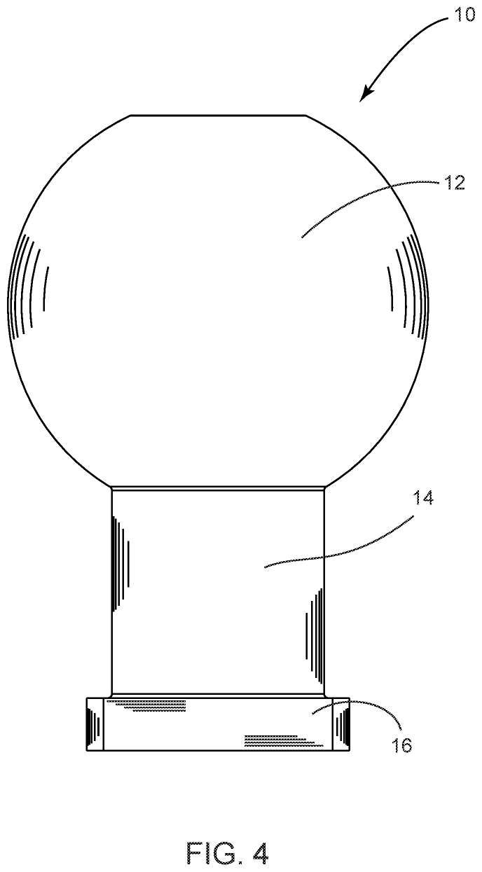

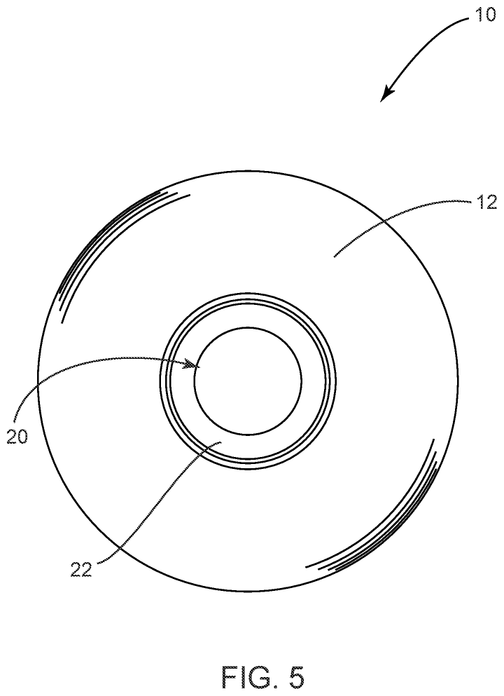

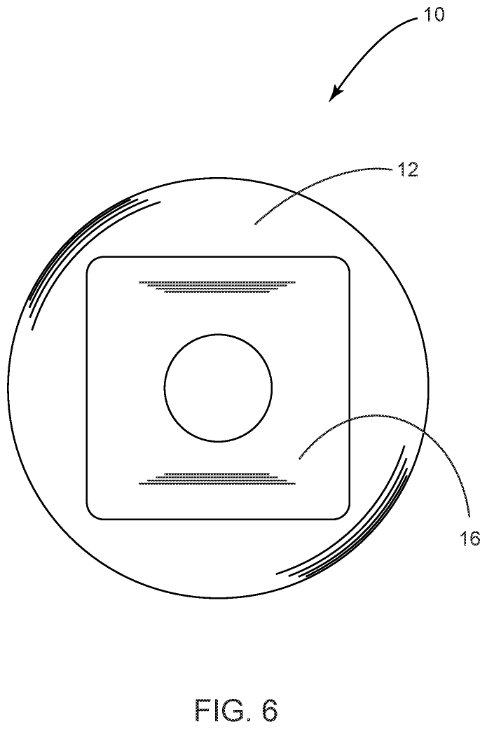

Referring to FIGS. 1-6, depicted is an embodiment of a ball mount 10 and a mounting base 30. In embodiments, the ball mount may generally include a ball portion 12, a shaft 14 and a rectilinear base 16, wherein the shaft 14 is coupled between the ball portion and the rectilinear base 16. The rectilinear base 16 is shown as a square, however, other rectilinear shapes may be utilized and operate in accordance with embodiments of the invention.

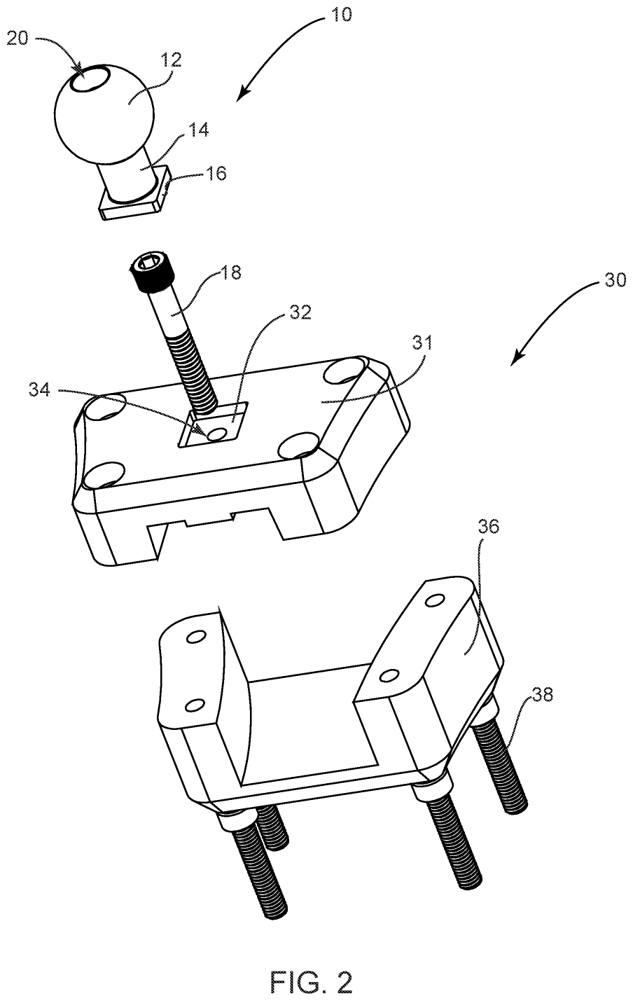

The mounting base 30 may include any type of mounting base. In some embodiments it may formed directly as part of a yoke or triple tree of a motorcycle, an original component of an off road vehicle like a UTV, ATV or the like, or it ma be a mounting base that is configured to couple to a vehicle aftermarket, such as what is shown in FIGS. 1-2. In these embodiments, the mounting base 30 may include a first member 31 having a recess 32 that has a corresponding rectilinear shape to the rectilinear base 16 of the ball mount 10. The mounting base 30 may also include a second member 36 that may be coupled to the first member 31 in order to clamp a component of the vehicle between the first member 31 and the second member 36 by use of bolts 38. The first and second members 31 and 36 may include recesses, channels and other geometry to enable the proper coupling of the mounting base 30 to a vehicle.

The ball mount 10 may further comprise an aperture 20 that extends through the ball portion 12, the shaft 14 and the rectilinear base 16. The aperture 20 is utilized to couple the ball mount 10 to the mounting base 30. In embodiments, the ball mount 10 is coupled to the mounting base 30 by inserting the rectilinear base 16 of the ball mount within the rectilinear recess 32 of the mounting base 30. This allows side surfaces and a bottom surface of the rectilinear base 16 of the ball mount 10 to engage side surfaces and a recessed surface of the rectilinear recess 32 of the mounting base 30, such that all surfaces are engaged when the ball mount 10 is coupled to the mounting base 30. A bolt 18 may then be inserted through the aperture 20 and couple to an aperture or recess 34 of the first member 31 of the mounting base 30. The aperture or recess 34 may be a threaded aperture or recess. Further, the ball 16 of the ball mount 10 may include a countersunk surface 22 that an end of the bolt 18 engages that operates to hold the ball mount 10 in contact with the mounting base 30 when the bolt 18 is coupled to the mounting base 30 through the aperture 20 of the ball mount 10.

In operation, embodiments include a method of using a ball mount 10. The method may include providing a ball mount 10 having the components as described above; coupling the ball mount to a mounting base with a bolt extending through the aperture and coupling to the mounting base; and inhibiting rotation of the ball mount in response to coupling the rectilinear base within a recess of the mounting base having a corresponding rectilinear shape. The shape of the base 16 of the ball mount 10 operates to engage the recess such that even during rough road conditions or surface of travel conditions, the vibrations of the vehicle do not result in the rotation of the ball mount. This inhibits the rotation of the ball mount 10 with respect to the mounting base 30. Preventing the rotation of the ball mount 10 with respect to the mounting base 30 reduces the opportunity of rotation of the bolt coupling the ball mount 10 to the mounting base 30. This then inhibits the ball mount 10 from loosening from the mounting base 30.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A ball mount comprising:
a ball portion;
a rectilinear base;
a shaft coupled between rectilinear base and the ball portion; and
an aperture extending through the ball portion, the shaft and the rectilinear base, wherein:
the ball mount is coupled to a mounting base with a bolt extending through the aperture and coupling to the mounting base; and
the rectilinear base is configured to couple to within a recess of the mounting base having a corresponding rectilinear shape to the rectilinear base of the ball mount.

2. The ball mount of claim 1, wherein the rectilinear base is a square base.

3. The ball mount of claim 2, wherein the square base comprises side surfaces and a bottom surface configured to engage side surfaces and a recessed surface of the rectilinear recess of the mounting base, such that all surfaces are engaged when the ball mount is coupled to the mounting base.

4. A ball mount system comprising:
a ball mount comprising:
a ball portion;
a rectilinear base;
a shaft coupled between rectilinear base and the ball portion; and
an aperture extending through the ball portion, the shaft and the rectilinear base; and
a mounting base configured to couple to a vehicle, the mounting base comprising a rectilinear recess having a corresponding shape to the rectilinear base of the ball mount, wherein:
the ball mount is coupled to the mounting base with a bolt extending through the aperture and coupling to the mounting base; and
the rectilinear base is configured to couple to within the rectilinear recess of the mounting base.

5. The system of claim 4, wherein the rectilinear base is a square base.

6. The system of claim 5, wherein the rectilinear recess of the mounting base is a square recess.

7. The system of claim 6, wherein the square base comprises side surfaces and a bottom surface configured to engage side surfaces and a recessed surface of the square recess of the mounting base, such that all surfaces are engaged when the ball mount is coupled to the mounting base.

8. A method of using a ball mount comprising:
providing a ball mount comprising:
a ball portion;
a rectilinear base;
a shaft coupled between rectilinear base and the ball portion; and
an aperture extending through the ball portion, the shaft and the rectilinear base;
coupling the ball mount to a mounting base with a bolt extending through the aperture and coupling to the mounting base; and
inhibiting rotation of the ball mount in response to coupling the rectilinear base within a recess of the mounting base having a corresponding rectilinear shape.

9. The ball mount of claim 8, wherein the rectilinear base is a square base.

10. The ball mount of claim 9, wherein the square base comprises side surfaces and a bottom surface configured to engage side surfaces and a recessed surface of the rectilinear recess of the mounting base, such that all surfaces are engaged when the ball mount is coupled to the mounting base.
